(19) United States
(12) Patent Application Publication
(10) Pub. No.: US 2021/0260813 A1
(43) Pub. Date: Aug. 26, 2021

(54) A SURFACE TREATMENT METHOD FOR A POLYMER FILM

(71) Applicant: Applied Materials, Inc., Santa Clara, CA (US)

(72) Inventor: Neil MORRISON, Darmstadt (DE)

(21) Appl. No.: 17/255,130

(22) PCT Filed: Jun. 28, 2018
(86) PCT No.: PCT/EP2018/067433

§ 371 Date: Dec. 22, 2020

(51) Int. Cl. B29C 59/14; B29C 59/12

(52) U.S. Cl. CPC B29C 59/14; B29C 2059/147; B29C 2059/145; B29C 59/12

(57) ABSTRACT

The present disclosure relates to a surface treatment method for a polymer film and to a use of a surface treated polymer film according to this method in the production of packaging material, in particular food packaging. The surface treatment method for a polymer film comprises providing information about at least the polymer film to a surface treatment device (102), adjusting at the surface treatment device at least one of a discharge of ions and a residence time of the polymer film in the surface treatment device based on the information (103), and applying the discharge of ions to a surface of the polymer film during the residence time of the polymer film in the surface treatment device to obtain a treated surface of the polymer film (104).

### TECHNICAL FIELD

Embodiments of the present disclosure relate to a surface treatment method for a polymer film. Further embodiments of the present disclosure relate particularly to the use of a surface treated polymer film in the production of packaging material, in particular food packaging.

### BACKGROUND

As a result of research and development, polymers have become the fastest growing segment of materials in the last decades, with hundreds of polymers being used in an increasing number of applications. For instance, one of these applications includes use of polymers in the production of polymer films for packaging a variety of products, particularly food.

Polymer films are selected for a given application on the basis of their physical, electrical, and chemical properties, e.g. thermal stability, coefficient of thermal expansion, toughness, dielectric constant, dissipation factor, solvent absorption, and chemical resistance. Although not all surfaces of polymer films possess the required physical and/or chemical properties for good adhesion, adhesive properties are seldom a criterion for polymer film selection. Accordingly, a polymer film for a given application is selected based, firstly, on other properties than adhesive properties. Thereafter, attention may be paid to adhesive properties of polymer films, in particular wherein polymer films are going to be used in applications together with other films or coatings (e.g. made of polymers or metals). In this regard, if the adhesive properties of a polymer film are not suitable to allow the polymer film to be used in such applications, a surface treatment of the polymer film may be an alternative. However, a surface treatment of polymer films is time consuming due to the several trial-and-error processes necessary for finding the optimum surface treatment conditions.

In view of the foregoing, there still exists a need for a surface treatment method of polymer films which avoid lengthy and expensive trial-and-error processes and accelerate the surface treatment of a polymer film, when the process parameters are still unknown.

### SUMMARY

Embodiments of the present disclosure relate to a surface treatment method for a polymer film. Further embodiments of the present disclosure relate to a use of a surface treated polymer film in the production of packaging material, in particular food packaging. The present disclosure particularly aims to improve the adhesion of polymer films by following a surface treatment method which comprises providing information about at least the polymer film to a surface treatment device. In particular, the present disclosure aims to provide a surface treatment method, wherein the optimum ion dose for surface treatment of a polymer film can be calculated by simply providing information about the polymer film such as material density of the polymer film. Further, the present disclosure aims to decrease the residence time of a polymer film in the surface treatment device and, therefore, accelerate the production of surface treated polymer films.

Further aspects, benefits, and features of the present disclosure are apparent from the claims, the description, and the accompanying drawings.

According to an aspect of the present disclosure a surface treatment method for a polymer film is provided. A surface treatment method comprises providing information about at least the polymer film to a surface treatment device, adjusting at the surface treatment device at least one of a discharge of charged particles and a residence time of the polymer film in the surface treatment device based on the information, and applying the discharge of charged particles to a surface of the polymer film during the residence time of the polymer film in the surface treatment device to obtain a surface treated polymer film.

According to a further aspect of the present disclosure, a use of a surface treated polymer film is provided. The use includes using a surface treated polymer film in the production of packaging material, in particular food packaging.

### BRIEF DESCRIPTION OF THE DRAWINGS

So that the manner in which the above recited features of the present disclosure can be understood in detail, a more particular description of the disclosure, briefly summarized above, may be had by reference to embodiments. The accompanying drawings relate to embodiments of the disclosure and are described in the following:

FIG. 1 shows a flow chart of a surface treatment method for a polymer film according to embodiments described herein; and

FIG. 2 shows a schematic view of a surface treatment device according to embodiments described herein.

### DETAILED DESCRIPTION OF EMBODIMENTS

Reference will now be made in detail to the various embodiments of the disclosure, one or more examples of which are illustrated in the figures. Within the following description of the drawings, the same reference numbers refer to same components. Generally, only the differences with respect to individual embodiments are described. Each example is provided by way of explanation of the disclosure and is not meant as a limitation of the disclosure. Further, features illustrated or described as part of one embodiment can be used on or in conjunction with other embodiments to yield yet a further embodiment. It is intended that the description includes such modifications and variations.

With the increasing use of polymer films in daily life (for instance, in food packaging), interest on the improvement of the production of polymer films has gained relevance in recent years.

A polymer film for a given application is selected based, firstly, on other properties than adhesive properties. Thereafter, attention may be paid to adhesive properties of polymer films, in particular wherein polymer films are going to be used in applications together with other films or coatings (e.g. made of polymers or metals).

A reason for adhesive properties having a secondary role in the selection of polymer films in some applications is the existence of different alternatives of modifying surfaces of polymer films that have been developed in recent years to improve the adhesive properties of polymer films to other films or coatings.

An example of such alternatives of modifying surfaces of polymer films is surface treatment of polymer films with plasma treatment devices. Plasma is an ionized gas phase substance that may include of ions, electrons, and neutral atoms and/or molecules that grossly maintain charge neutrality. Except boundary regions between plasma and electrons, plasma contains same amount of positive and negative charges. Further, charged particles in plasma response collectively to an external electromagnetic field.

In the surface treatment of polymer films with plasma treatment devices, energetic particles (e.g. ions and/or electrons) generated in the plasma interact strongly with the surface of polymer films, usually via free radical chemistry. In general, four major effects of plasma on surfaces of polymer films are normally observed. Each effect is always present to some degree, but one of the effects may be favored over the other effects, depending on the polymer film, process gas, plasma treatment device, and process parameters.

Accordingly, the four major effects are: (a) surface cleaning, that is, removal of organic contamination from the surface of the polymer film; (b) ablation, or etching, of material from the surface of the polymer film, which can remove a weak boundary layer and increase the surface area; (c) crosslinking or branching of near-surface polymeric molecules, which can cohesively strengthen the surface of the polymer film; and (d) modification of surface-chemical structure of the polymer film, which can occur during surface treatment of polymer films with a plasma treatment device itself, and upon re-exposure of the treated part of the polymer film to air, at which time residual free radicals can react with atmospheric oxygen or water vapor.

Further, during the surface treatment of polymer films, electrons and ions in plasmas can disappear through diffusion or recombination. To sustain a stable plasma, external excitation is required to create more electrons and ions so that their creation rate can reach a balance with the loss rate. Most of the plasma generation methods rely on giving enough energy to electrons to break down neutral atoms or molecules into ions and electrons. Some plasma sources applying such plasma generation methods are glow discharge, corona discharge, capacitively coupled discharge, inductively coupled discharge, and electron cyclotron resonance (ECR).

In particular, one plasma treatment devices used to improve the adhesive properties of polymer films is a corona treatment device. A corona treatment device uses a low temperature corona discharge plasma to impart changes in the properties of a surface. For instance, a corona treatment device is designed to increase the surface energy of polymer films and paper in order to allow improved adhesion of coatings such as inks and adhesives. As a result, the surface treated polymer films demonstrate improved printing and adhesion quality and lamination strength.

A corona treatment device may include two major components: a power supply, which comprises a high-frequency power generator and a high-voltage transformer, and a treater station comprising a plasma source with at least an electrode and a treater ground roll. The power supply of a corona treatment device accepts standard 50/60 Hz utility electrical power and converts it into single phase, higher frequency (nominally 10 to 30 kHz) power that is supplied to the treater station. The treater station applies this power to the surface of the material, e.g. polymer film, through an air gap, via a pair of electrodes at high potential and roll at ground potential which supports the material. Only the side of the material facing the high potential electrode of the treater station should show an increase in surface tension.

In particular, the effects of plasma on the surface of a polymer film can be mainly controlled by varying various process parameters such as plasma-source pressure, plasma power supply, type of process gas, process gas flow, duration of treatment (or treatment speed), and distance of the plasma from the substrate surface. Several of the above-mentioned effects can therefore be achieved in a single process step by controlling such process parameters. However, in order to acquire process knowledge on the treatment of a determined polymer film and to find the optimum conditions to achieve an specific effect on the surface of a polymer film, lengthy and expensive trial-and-error processes have to be conducted.

According to embodiments described herein, surface treatment of polymer films is improved, in particular, wherein polymer films are used in applications together with other films or coatings (e.g. made of polymers or metals) and, therefore, specific adhesive properties of the polymer films are demanded.

Due to lengthy and expensive trial-and-error processes to find optimum conditions to treat a surface of a polymer film, a surface treatment method for a polymer film with an increased simplicity and reduced production time of polymer films has been sought.

Accordingly, the present disclosure relates to a surface treatment method for a polymer film and a use of a surface treated polymer film according to this method in the production of packaging material, in particular food packaging. The surface treatment method for a polymer film comprises providing information about at least the polymer film to a surface treatment device, adjusting at the surface treatment device at least one of a discharge of charged particles and a residence time of the polymer film in the surface treatment device based on the information, and applying the discharge of charged particles to a surface of the polymer film during the residence time of the polymer film in the surface treatment device to obtain a treated surface of the polymer film.

According to embodiments of the present disclosure, which can be combined with other embodiments described herein, the polymer film may be treated with charged particles, such as electrons or ions. Electrons may be generated in an electron source, e.g. utilizing a plasma, a thermal electron emission or a field emission of electrons. Ions may be generated in an ion source as described herein. In the following reference is made to ions, as ions may beneficial for easier surface modification.

Before various embodiments of the present disclosure are described in more detail, some aspects with respect to some terms and expressions used herein are explained.

The term “polymeric coating” refers to a thin layer made of polymeric material which has been applied on a substrate or material such as a polymer film using a number of different techniques such as extrusion/dispersion and solution application.

The term “polymeric film” is to be understood as a piece of material made of polymers with a thickness of less than 100 μm, typically of less than 50 μm, and more typically 20 μm. Further, the polymeric film may have a width of 1 m or above, typically 2 m or above. The length in a roll-to-roll (R2R) process can vary from a few hundred meters to kilometers. The term “surface” refers to an exterior extent or area of a piece of material.

The term “plasma” usually describes a partially ionized gas composed of ions, electrons, and neutral species. The term “plasma” may also refer to a mixture of electrons and positively charged ions created when matter is continually supplied with energy, for instance, by increasing the temperature and/or applying high voltage at specific frequencies. The term “discharge of ions” refers to a group positively charged ions created when matter is continually supplied with energy, for instance, by increasing the temperature and/or applying high voltage at specific frequencies. The term “discharge of ions” also refers to a group positively charged ions being part of a plasma.

The term “power supply” is to be understood as an electrical device that supplies electric current or electrical voltage to a plasma source. The term “plasma source” refers to a part of a plasma treatment device that generates plasma by applying an electric field or a beam of electrons and photons to a process gas.

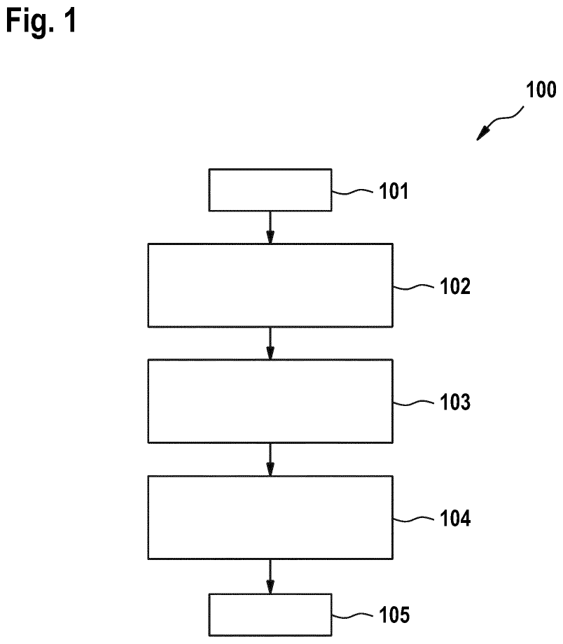

FIG. 1 shows a flowchart of a surface treatment method 100 for a polymer film according to embodiments described herein. The method 100, beginning at start 101, includes providing information about at least the polymer film to a surface treatment device 102, adjusting at the surface treatment device at least one of a discharge of ions and a residence time of the polymer film in the surface treatment device based on the information 103, and applying the discharge of ions to a surface of the polymer film during the residence time of the polymer film in the surface treatment device to obtain a surface treated polymer film 104. Method 100 concludes at end 105.

In some embodiments, which can be combined with other embodiments described herein, a polymer film may comprise at least one of polyolefin, polyester, polyurethane, polyacrylate, and polysiloxane. In addition, at least part of a surface of a polymer film may comprise a polymeric coating. The polymeric coating may comprise at least one of polyolefin, polyester, polyurethane, polyacrylate, and polysiloxane. In particular, a polyolefin may comprise at least one of polyethylene and polypropylene. Further, a polyester may comprise at least polyethylene terephthalate. Furthermore, a polyacrylate may comprise at least one of polymethacrylate, poly(methyl)methacrylate, polyacrylonitrile, and polyacrylamide. Hereafter the polymeric coating may not be mention in further embodiments. However, a polymeric coating may be provided on at least a part of the surface of a polymer film in the embodiments as described herein.

Further, providing information about at least the polymer film to a surface treatment device 102 may further comprise providing at least one of a material density of the polymer film and a surface atom density of the polymer film. Furthermore, providing information about at least the polymer film to a surface treatment device may further comprise providing information about the polymeric coating to the surface treatment device including providing at least one of a material density of the polymeric coating and a surface atom density of the polymeric coating.

Accordingly, the term “material density” refers to the mass of a polymer included in a polymer film or a polymeric coating per unit of volume of the polymer film or the polymeric coating. The material density in the present disclosure may be determined by using a gas pycnometer according to ISO 12154:2014. Further, the material density of a polymer can be found, for instance, in a database or a data sheet which contains information about at least one of the polymers included in a polymer film or a polymeric coating.

Furthermore, the term “surface atom density” is to be understood as a number of atoms of a polymer on a surface of a polymer film or a polymeric coating per unit of area of the polymer film or the polymeric coating.

According to some embodiments, which can be combined with other embodiments described therein, a surface treatment method may include a further processing of solvent wiping and/or chemical treatment. Accordingly, solvent wiping may be conducted by applying a solvent on a surface of a polymer film and removing the solvent together with any solute such as waxes, oils, and/or any other low molecular weight contaminants from the surface of the polymer film by wiping.

Further, chemical treatment may be conducted by applying a chemical on a surface of a polymer film that reacts with any contaminant from the surface of a polymer film and/or with the polymer film. Examples of chemical treatments may include etchant treatment on the surface of polymer films comprising polytetrafluoroethylene (PTFE), addition of caustic soda to the surface of polymer films comprising polyesters, and addition of sulphuric acid to the surface of polymer films comprising polystyrene.

According to embodiments described herein, the surface atom density of the polymer film and/or the polymeric coating can be provided. At least one of a material density of the polymer film and a surface atom density of the polymer film and/or at least one of a material density of the polymeric coating and a surface atom density of the polymeric coating may be obtainable by information provided and calculating with an algorithm the surface atom density of at least one of the polymer film and the polymeric coating based on the information about at least one of the polymer film and the polymeric coating. Accordingly, the surface atom density of the polymer film and/or the polymeric coating in the present disclosure can be calculated by applying arithmetic operations, for instance, addition, subtraction, division or multiplication on a material density.

In some embodiments, which can be combined with other embodiments described herein, the surface treatment device is adjusted (see box 103 in FIG. 1). The adjustment can be based on at least one of a discharge of ions and a residence time of the polymer film in the surface treatment device based on the information. An adjustment may further comprise at least one of calculating with an algorithm an ion dose for treatment of at least one of the polymer film and/or the polymeric coating. The calculating may be based on at least a discharge electric current, an electrode area, and the residence time. Further calculating may be provided by an algorithm to obtain an ion energy for treatment of at least one of the polymer film and the polymeric coating. Yet further, the adjustment may additionally or alternatively include calculating the residence time of the polymer film in the surface treatment device based on at least one dimension of the surface treatment device in the machine direction and a polymer film conveyance speed in the machine direction, and selecting a process gas.

Accordingly, the term “discharge electric current” refers to an electric current provided by a power supply to a plasma source of a plasma treatment device. The term “electrode area” refers to an area of an electrode being part of a plasma source and used to generate plasma. The term “residence time” is to be understood as a period of time which a polymer film spends in a surface treatment device. In particular, the term “residence time” refers to a period of time, wherein plasma is applied on a surface of a polymer film or polymeric coating in a surface treatment device.

Further, the term “ion dose” refers to the number of positively charged ions from plasma applied to a polymer film or a polymeric coating per area of the polymer film or polymeric coating. The term “ion energy” is to be understood as the amount of energy of a positively charged ion from plasma equivalent to the energy gained by an electron when the electrical potential at the electron increases by one volt. The term “dimension of the surface treatment device in the machine direction” refers to a linear extension of a plasma source, particularly in direction of substrate movement, in which the polymer film flows onto the surface treatment device. The term “polymer film conveyance speed in the machine direction” is to be understood as the rate at which a polymer film is transported at a surface treatment device in the direction in which the polymer film flows onto the surface treatment device.

The ion dose applied to a polymer film and/or the polymeric coating in the present disclosure can be calculated by applying arithmetic operations, for instance, addition, subtraction, division or multiplication on at least one of a discharge electric current, electrode area, and residence time. Similarly, the residence time of a polymer film in the surface treatment device in the present disclosure can be calculated with an algorithm applying arithmetic operations, for instance, addition, subtraction, division or multiplication on at least one dimension of the surface treatment device in the machine direction and a polymer film conveyance speed in the machine direction.

Accordingly, the ion dose for treatment of at least one of the polymer film and/or the polymeric coating comprises 4×10¹⁴ to 6×10¹⁵ ions/cm², typically 6×10¹⁴ to 4×10¹⁵ ions/cm², more typically 8×10¹⁴ to 2×10¹⁵ ions/cm². Further, the ion energy for treatment of at least one of the polymer film and/or the polymeric coating comprises 100 eV to 9000 eV, typically 200 eV to 7000 eV, more typically 400 eV to 5000 eV.

The surface treatment device may be a plasma treatment device. The plasma treatment device may comprise at least a power supply and a treater station. Further, the treater station may comprise at least a plasma source with at least an electrode and a treater ground roll. Furthermore, the power supply may provide electric current to a plasma source of a plasma treatment device. The power supply can be unipolar or bipolar. The term “unipolar” refers to a power supply that has two output terminals, positive and negative. The term “bipolar” refers to a power supply that has three output terminals, positive, ground, and negative.

Further, the electric current may be at least one of low frequency RF, high frequency RF, MF, DC, and AC. The terms “AC” and “DC” refer to electric current applied with a power supply to a plasma source. The term “AC” refers to alternating electric current, wherein the direction of the electric current flow changes with respect to time. The term “DC” refers to direct electric current, wherein the electric current is constant and the direction of the electric current flow stays permanently during all application of electric current with a power supply to a plasma source. The term “electric current” refers to a continuous flow of electrons that move through a conductor and may be generated by a potential difference across two differently charged ends of a conductor.

Furthermore, the term “radio frequency” refers to oscillatory change in voltage or electric current applied with a power supply to a plasma source. Further, the term “radio frequency” relates to the term “AC”. The term “RF” refers to radio frequency and relates to frequencies above 100 kHz and below 915 MHz, typically above 1 MHz and below 900 MHz. The term “MF” refers to mid-frequency and relates to frequencies above 16 kHz and below 100 kHz, typically above 20 kHz and below 50 kHz.

According to some embodiments, which can be combined with other embodiments described therein, the plasma treatment device may comprise a plasma source that generates plasma by applying an electric field, for instance, by applying a DC or AC current, a radio frequency current, a microwave discharge or a beam of electrons and photons to a process gas. The plasma treatment device may comprise a plasma source that generates plasma by at least one of glow discharge, bipolar magnetron, capacitively coupled discharge, inductively coupled discharge, microwave discharge, and electron cyclotron resonance.

Accordingly, the term “glow discharge” refers to a plasma source that generates plasma by the passage of electric current, typically DC or low frequency RF, through a process gas. The term “glow discharge” also refers to a plasma source that generates plasma by applying a voltage between two electrodes containing a process gas. The term “bipolar magnetron” refers to a plasma source that generates plasma by using two magnetrons connected to the same power supply (AC), wherein the magnetrons may be pulsed 180° out of phase to each other, such that each acts alternately as a cathode and an anode. The term “capacitively coupled discharge” is to be understood as a plasma source that generates plasma by the passage of electric current, typically high frequency RF, more typically 13.56 MHz, through a process gas. The term “inductively coupled discharge” refers to a plasma source that generates plasma by applying a voltage between two electrodes containing a process gas, wherein the electrodes may be coils wrapped around a chamber where plasma is formed.

Further, the term “microwave discharge” refers to a plasma source that generates a plasma by applying a microwave radiation through a quartz window to a process gas, wherein the plasma source may include a magnetron. The term “electron cyclotron resonance” refers to a plasma source that generates a plasma by applying microwaves with a frequency of 2.45 GHz via a transmission line and a magnetic field strength of 0.0875 T to a gas process.

Further, the plasma treatment device may be a vacuum plasma treatment device or an atmospheric plasma treatment device. The vacuum plasma treatment device can be used in a batch process. The atmospheric plasma treatment device can be used in an assembly-line process. The term “vacuum” refers to pressures below an atmospheric pressure, typically below 10 torr.

The process gas may be inorganic or organic. As example, the inorganic process gas may comprise at least one of argon, oxygen, nitrogen, helium, and neon, typically at least one of argon, oxygen, nitrogen, helium, and more typically at least one of argon, oxygen, and nitrogen. Exemplary organic process gases include silanes, saturated and unsaturated hydrocarbons and aromatics.

The surface treatment method may further comprise analyzing a treated surface of the polymer film and/or analyzing a treated polymeric coating. Accordingly, analyzing a treated surface of the polymer film and/or analyzing a treated polymeric coating may comprise using one of tape test for measuring adhesion strength according to ISO 29862:2007, spectroscopic methods such as Fourier-transform infrared, ultraviolet, and X-ray photoelectron spectroscopies, and measuring a contact angle or wettability.

The surface treated polymer film according to the present disclosure can be use in roll-to-roll applications (R2R application). For example, applications may include the production of packaging material, in particular food packaging, touch panel applications, flexible electronic device applications, barrier film applications, ultra-high barrier film applications, and applications for optical layers, such as optical layer stacks.

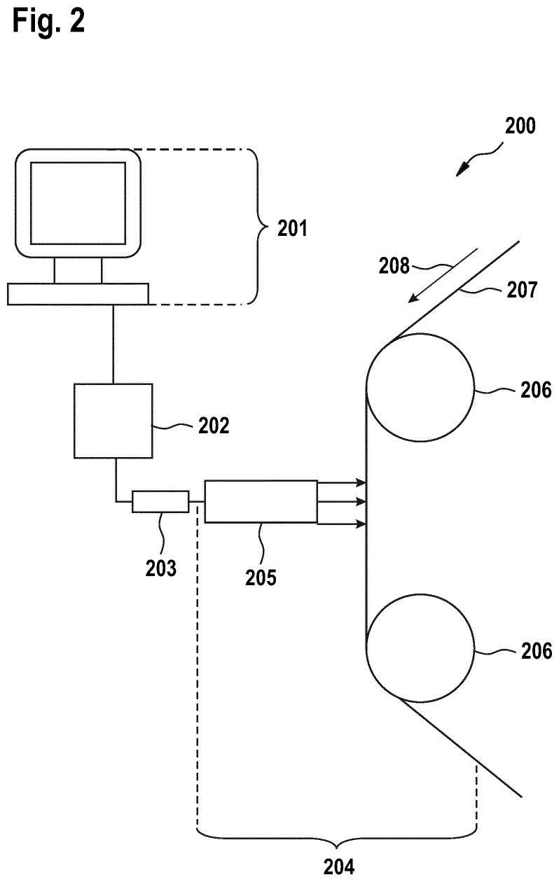

FIG. 2 shows a schematic view of a surface treatment device 200 according to embodiments described herein.

According to some embodiments, which may be combined with other embodiments described herein, the surface treatment device 200 may include a computer 201, a controller unit 202, a power supply 203, and a treater station 204. Further, information about at least a polymer film 207 may be provided to the surface treatment device through computer 201. The controller unit 202 may be capable of controlling at least the power supply 203. The surface treatment device 200 may be a plasma treatment device. The plasma treatment device may comprise a plasma source 205. The power supply may provide electric current to the plasma source 205. The polymer film 207 may be conducted through the surface treatment device 200 in the machine direction 208, e.g. over rollers 206.

While the foregoing is directed to embodiments of the disclosure, other and further embodiments of the disclosure may be devised without departing from the basic scope thereof, and the scope thereof is determined by the claims that follow.

1. A surface treatment method for a polymer film, comprising:
providing information about at least the polymer film to a surface treatment device;
adjusting at the surface treatment device at least one of a discharge of charged particles, and a residence time of the polymer film in the surface treatment device based on the information; and
applying the discharge of charged particles to a surface of the polymer film during the residence time of the polymer film in the surface treatment device to obtain a surface treated polymer film
wherein providing information about at least the polymer film to a surface treatment device further comprises providing at least one of a material density and a surface atom density.

2. The surface treatment method according to claim 1, wherein at least part of the surface of the polymer film comprises a polymeric coating.

3. The surface treatment method according to claim 2, wherein the polymeric coating comprises at least one of polyolefin, polyester, polyurethane, polyacrylate, and polysiloxane.

4. (canceled)

5. The surface treatment method according to claim 1, wherein providing at least one of a material density and a surface atom density comprises providing at least one of a material density of the polymer film, a surface atom density of the polymer film, a material density of the polymeric coating, and a surface atom density of the polymeric coating.

6. The surface treatment method according to claim 1, wherein providing at least one of a material density and a surface atom density further comprises calculating with an algorithm the surface atom density of at least one of the polymer film and the polymeric coating based on the information about at least one of the polymer film and the polymeric coating.

7. The surface treatment method according to claim 1, wherein adjusting at the surface treatment device at least one of a discharge of charged particles and a residence time of the polymer film in the surface treatment device based on the information further comprises at least one of:
calculating with an algorithm a charged particle dose for treatment of at least one of the polymer film and the polymeric coating based on at least one of a discharge electric current, an electrode area, and the residence time;
calculating with an algorithm a charged particles energy for treatment of at least one of the polymer film and the polymeric coating;
calculating with an algorithm the residence time of the polymer film in the surface treatment device based on at least one dimension of the surface treatment device in the machine direction and a polymer film conveyance speed in the machine direction; and
selecting a process gas.

8. The surface treatment method according to claim 1, wherein the polymer film comprises at least one of polyolefin, polyester, polyurethane, polyacrylate, and polysiloxane.

9. The surface treatment method according to claim 3, wherein the polyolefin comprises at least one of polyethylene and polypropylene, the polyester comprises at least polyethylene terephthalate, or the polyacrylate comprises at least one of polymethacrylate, poly(methyl)methacrylate, polyacrylonitrile, and polyacrylamide.

10. The surface treatment method according to claim 1, wherein the method further comprises at least one of analyzing the treated surface of the polymer film and analyzing a treated polymeric coating.

11. The surface treatment method according to claim 7, wherein the process gas is inorganic.

12. The surface treatment method according to claim 1, wherein the surface treatment device is an electron treatment device of a plasma treatment device.

13. The surface treatment method according to claim 7, wherein the charged particle dose for treatment of at least one of the polymer film and the polymeric coating comprises 4×10¹⁴ to 6×10¹⁵ charged particles/cm².

14. The surface treatment method according to claim 7, wherein the charged particles energy for treatment of at least one of the polymer film and/or the polymeric coating comprises 100 eV to 9000 eV.

15. A surface treatment method for a polymer film, comprising:
providing information about at least one of the polymer film and a polymeric coating to a surface treatment device;
calculating with an algorithm the surface atom density of at least one of the polymer film and the polymeric coating based on the information about at least one of the polymer film and the polymeric coating
calculating with an algorithm the residence time of the polymer film in the surface treatment device based on at least one dimension of the surface treatment device in the machine direction and a polymer film conveyance speed in the machine direction;
calculating with an algorithm a charged particle dose for treatment of at least one of the polymer film and the polymeric coating based on at least one of a discharge electric current, an electrode area, and the residence time;
adjusting at the surface treatment device at least one of a discharge of charged particles and a residence time of the polymer film in the surface treatment device based on the information; and
applying the discharge of charged particles to a surface of the polymer film during the residence time of the polymer film in the surface treatment device to obtain a surface treated polymer film.

16. The surface treatment method according to claim 11, wherein the process gas comprises at least one of argon, oxygen, nitrogen, helium, and neon.

17. The surface treatment method according to claim 12, wherein a plasma source of the plasma treatment device is at least one of glow discharge, bipolar magnetron, capacitively coupled discharge, inductively coupled discharge, microwave discharge, and electron cyclotron resonance.

18. The surface treatment method according to claim 13, wherein the charged particle dose for treatment of at least one of the polymer film and the polymeric coating comprises 6×1014 to 4×1015 charged particles/cm2.

19. The surface treatment method according to claim 13, wherein the charged particle dose for treatment of at least one of the polymer film and the polymeric coating comprises 8×1014 to 2×1015 charged particles/cm2.

20. The surface treatment method according to claim 14, wherein the charged particle energy for treatment of at least one of the polymer film and the polymeric coating comprises 200 eV to 7000 eV.
